(19) United States
(12) Patent Application Publication
(10) Pub. No.: US 2016/0144411 A1
(43) Pub. Date: May 26, 2016

(54) WASHER

(71) Applicant: HITACHI KOKI CO., LTD., Minato-ku, Tokyo (JP)

(72) Inventors: Noriyuki HORIE, Ibaraki (JP); Naoki TADOKORO, Ibaraki (JP)

(73) Assignee: Hitachi Koki Co., Ltd., Tokyo (JP)

(21) Appl. No.: 14/899,442

(22) PCT Filed: Aug. 7, 2014
(86) PCT No.: PCT/JP2014/004133

§ 371 Date: Dec. 17, 2015

(30) Foreign Application Priority Data
Aug. 9, 2013 (JP) 2013-167059

(51) Int. Cl. B08B 3/02

(52) U.S. Cl. CPC B08B 3/02

(57) ABSTRACT

A washer includes: a tank which stores washer fluid; a pump which pressurizes the wash fluid supplied from the tank; a main body including an electric-powered motor which is a driving source of the pump and a battery pack which is a power source of the electric-powered motor; a spray device including a nozzle; and a pressure-resistant hose which connects the main body with the spray device. A discharge pressure (A) of the washer fluid is 0.5 [MPa] or higher and 9.0 [MPa] or lower, and a pressure liquid volume ratio (A/B) which is a ratio of a discharge volume (B) of the washer fluid with respect to the discharge pressure (A) of the washer fluid is 1.8 or larger.

### TECHNICAL FIELD

The present invention relates to a washer for washing a substance to be washed by discharging pressurized liquid.

### BACKGROUND ART

The washer as described above has a main body provided with a pump for pressurizing the liquid and a spray device connected to the main body. The spray device is provided with a nozzle from which the liquid pressurized and fed from the main body is discharged (see Patent Literature 1). Note that the discharged (sprayed) liquid from the washer may be tap water or liquid containing a detergent, a polish, or others. Accordingly, in the present specification, the discharged (sprayed) liquid from the washer may be referred to as “washer fluid” for a generic name. Also, the substance to be washed by the discharged (sprayed) liquid from the washer may be referred to as “target object” for a generic name.

### CITATION LIST

### Patent Literature

PTL 1: Japanese Patent Application Laid-Open Publication No. 2005-313008

### SUMMARY OF INVENTION

### Technical Problem

In one conventional washer, the main body and a faucet of the tap water are connected to each other through a hose. In another conventional washer, a tank for storing the washer fluid is provided. To the former washer, the washer fluid (tap water) is continuously supplied. That is, there is no limitation on an available volume of the washer fluid during an operation. On the other hand, in the latter washer, when the washer fluid stored in the tank is consumed, the operation must be discontinued to refill the washer fluid in the tank. Therefore, in order to extend the continuous operation time, it is required to increase a tank volume or to decrease a discharge volume of the washer fluid per unit time. However, the increase in the tank volume increases a size of the washer. Also, when the tank with a large volume if filled with the washer fluid, the tank is heavy, and therefore, a load on an operator who carries the tank increases.

Meanwhile, washing ability of the washer depends on a product (discharge pressure×discharge volume) of a pressure (discharge pressure) of the washer fluid with a volume (discharge volume) of the washer fluid. Therefore, such a simple way as decrease in the discharge volume of the washer fluid decreases the washing ability.

A preferred aim of the present invention is to keep the necessary and sufficient washing ability as suppressing the discharge volume of the washer fluid.

### Solution to Problem

A washer of the present invention is a washer which pressurizes and discharges the washer fluid supplied from the tank. A discharge pressure (A) of the washer fluid in this washer is 0.5 [MPa] or larger and 9.0 [MPa] or smaller. Also, a pressure liquid volume ratio (AB) which is a ratio of a discharge volume (B) [L/min] of the washer fluid with respect to the discharge pressure (A) [MPa] of the washer fluid is 1.8 or larger.

In one aspect of the present invention, the discharge pressure (A) is 0.5 [MPa] or larger and 3.0 [MPa] or smaller.

In another aspect of the present invention, the discharge pressure (A) is the maximum discharge pressure.

In still another aspect of the present invention, the discharge volume (B) is 1 [L/min].

In still another aspect of the present invention, the washer has a nozzle provided with: a flow inlet to which the washer fluid is flowed; a discharge outlet from which the washer fluid is discharged; and a flow path through which the flow inlet and the discharge outlet communicate with each other. The minimum value of a diameter of the flow path is 0.9 [mm] or smaller.

In still another aspect of the present invention, the washer has: a main body; a spray device provided with the nozzle; and a tube member which connects the main body with the spray device. The main body is provided with: a tank for storing the washer fluid; a pump for pressurizing the washer fluid supplied from the tank; an electric-powered motor which is a driving source of the pump; and a secondary battery which is a power source of the electric-powered motor.

In still another aspect of the present invention, the secondary battery can supply power of 140 [W] or larger to the electric-powered motor.

In still another aspect of the present invention, the power supplied to the electric-powered motor by the secondary battery is a power provided when a first conversion efficiency (c1) for converting the power of the secondary battery into rotating motion of the electric-powered motor is 50% to 80%.

In still another aspect of the present invention, the power required for driving the pump is 70 [W] or larger.

In still another aspect of the present invention, the power required for driving the pump is a power provided when a second conversion efficiency (c2) for converting the rotating motion of the electric-powered motor into reciprocating motion of the pump is 50% to 80%.

In still another aspect of the present invention, the secondary battery can supply a power of 20 [Wh] or larger to the electric-powered motor.

In still another aspect of the present invention, the pump includes a single reciprocating member driven by the electric-powered motor, and the discharge pressure is pulsed by the single reciprocating member.

In still another aspect of the present invention, the discharge pressure pulses with a variation rate of 20% or larger.

In still another aspect of the present invention, the secondary batter is used for an electric-powered tool.

Another washer of the present invention is a washer which pressurizes and discharges the washer fluid supplied from the tank. This washer is provided with a cylinder and a plunger housed in the cylinder so as to freely reciprocate, and has: a pump for pressurizing the washer fluid; and a crankshaft for converting the rotating motion of the electric-powered motor into the reciprocating motion of the plunger. And, to the crankshaft, a counterweight which rotates together with the crankshaft is provided.

Still another washer of the present invention is a washer which pressurizes and discharges the washer fluid supplied from the tank. This washer is provided with a cylinder and a plunger housed in the cylinder so as to freely reciprocate, and has: a pump for pressurizing the washer fluid; a conversion mechanism for converting the rotating motion of the electric-powered motor into the reciprocating motion of the plunger; a main body in which the pump and the conversion mechanism are housed; a spray device connected to the main body through a tube member; a connection port provided to the main body and connected to one end of the tube member; and a linear flow path through which the pump and the connection port are communicated with each other. And, the plunger and the flow path are arranged on the same plane as each other.

### Advantageous Effect of Invention

According to the present invention, the necessary and sufficient washing ability can be maintained as suppressing the discharge volume of the washer fluid.

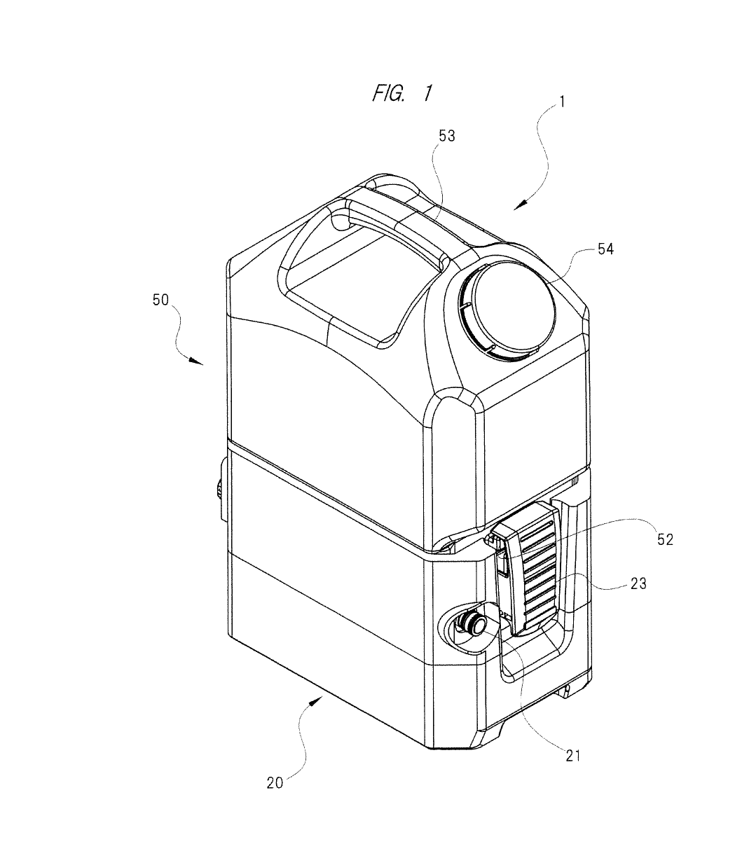

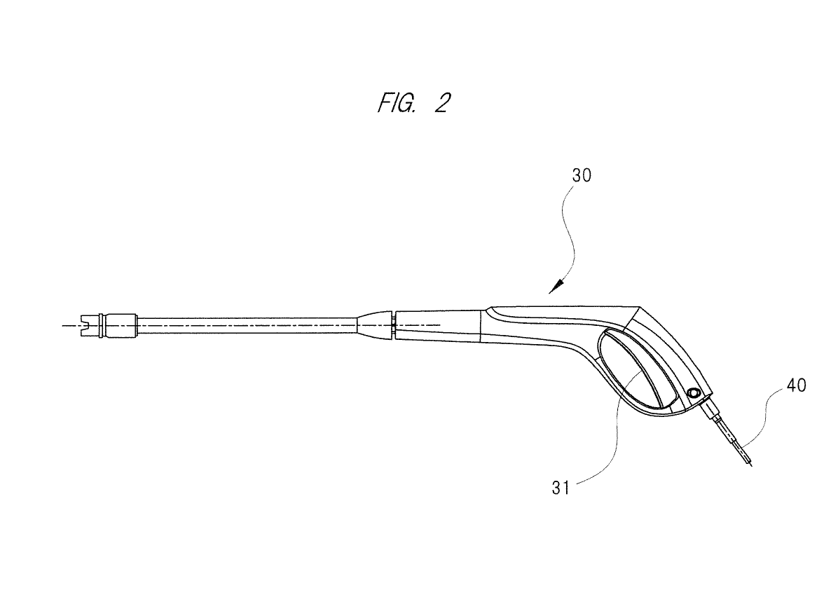

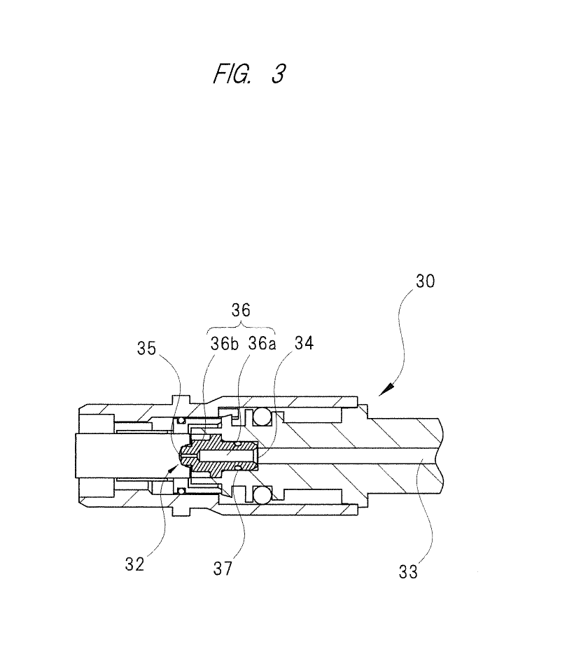

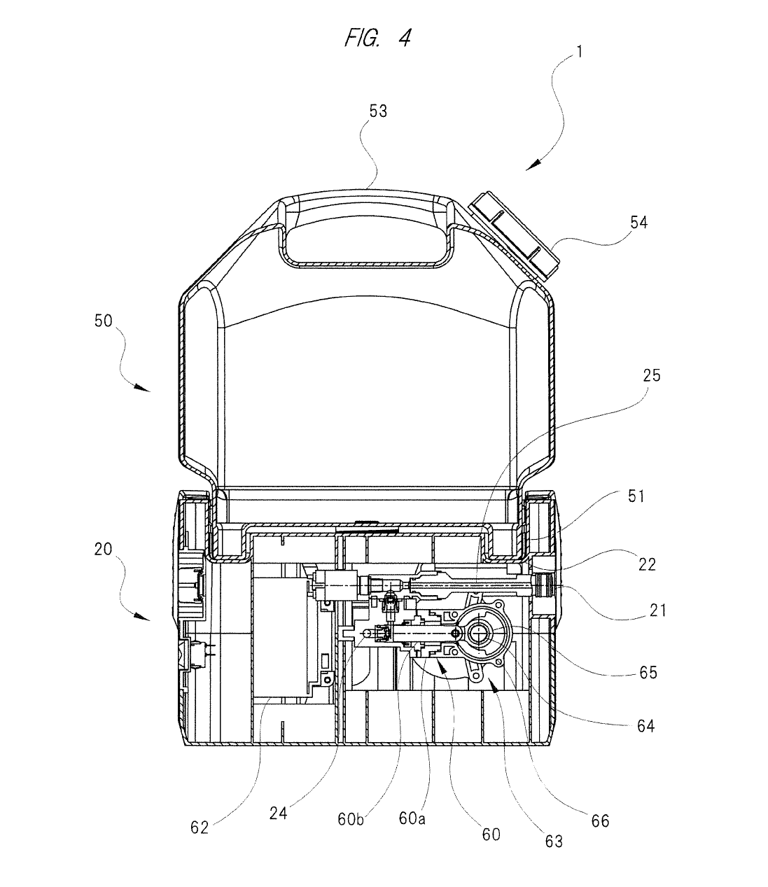

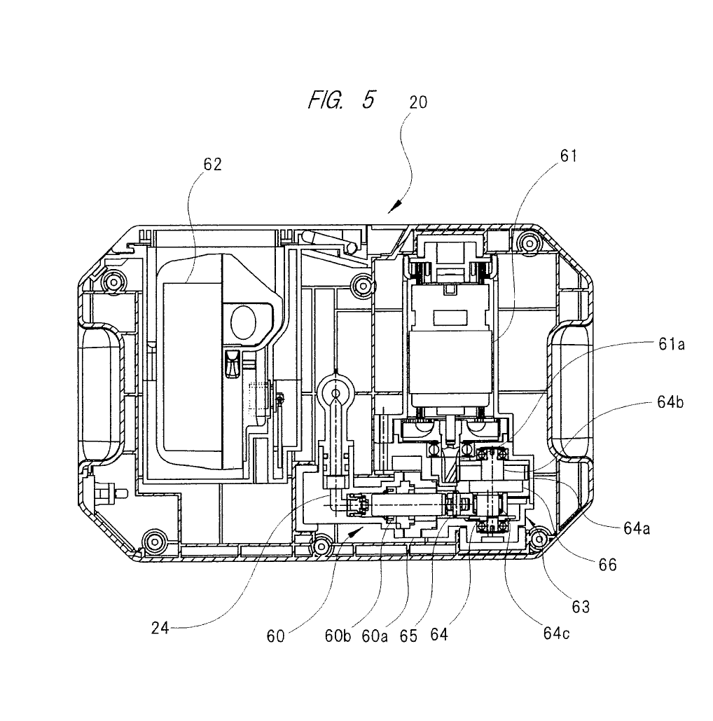

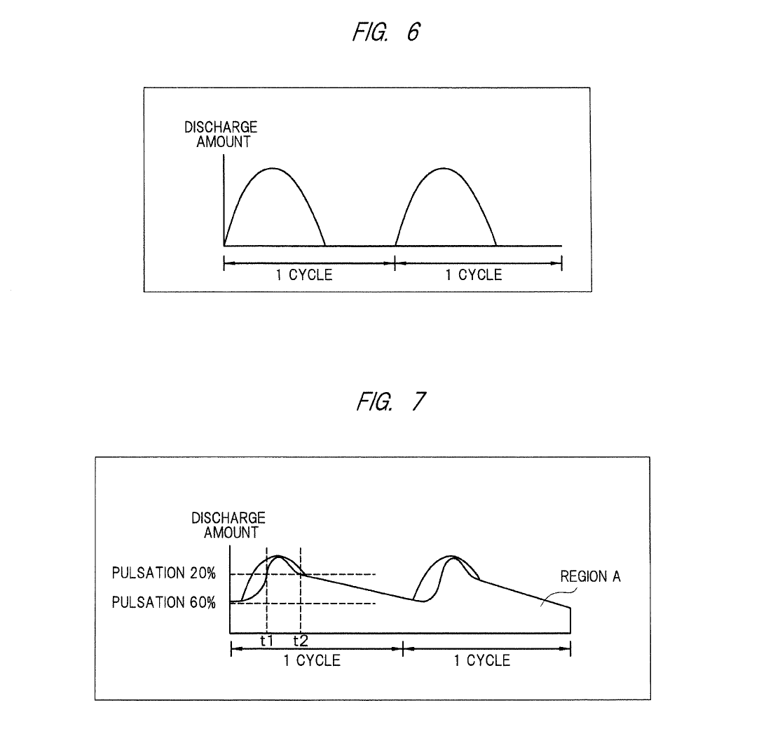

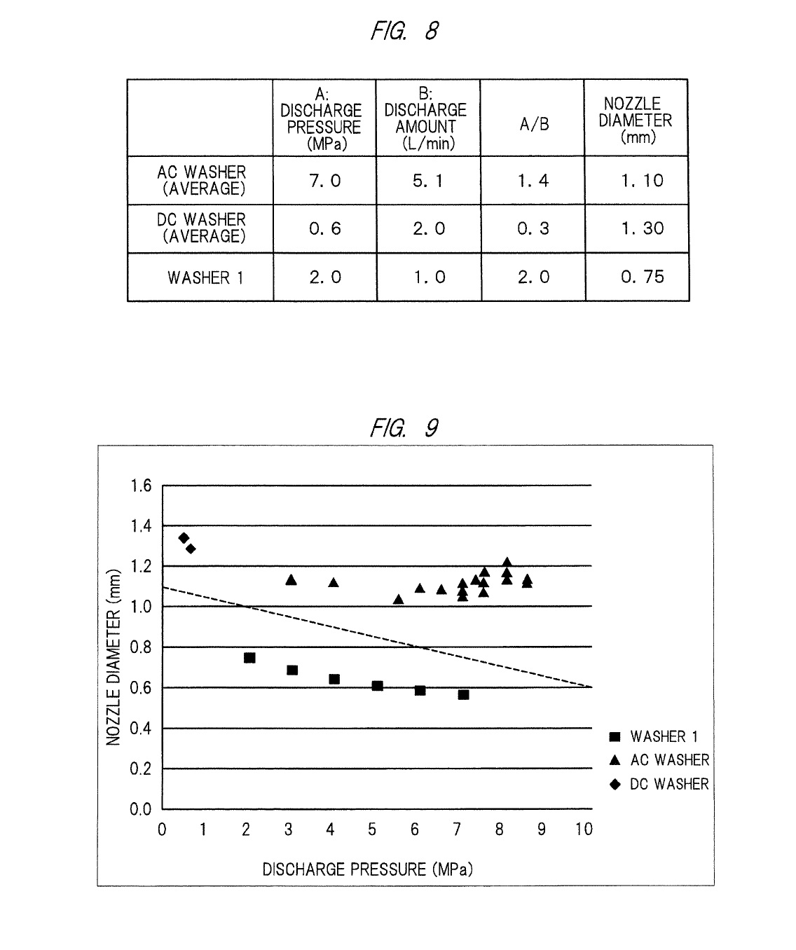

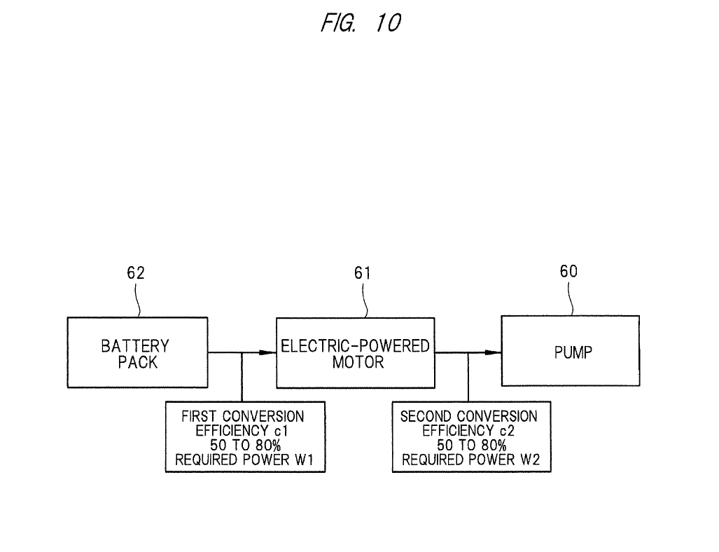

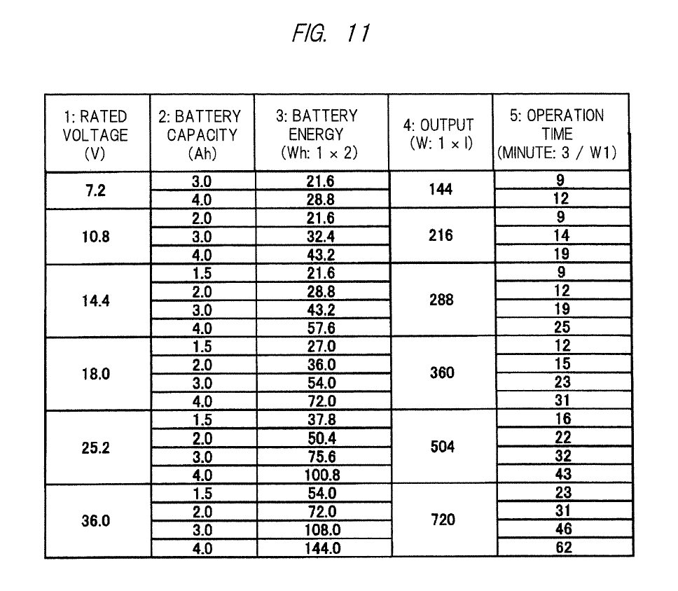

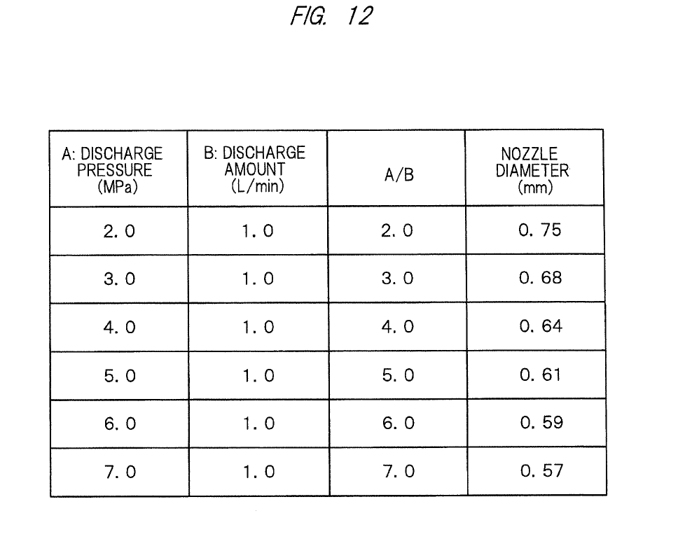

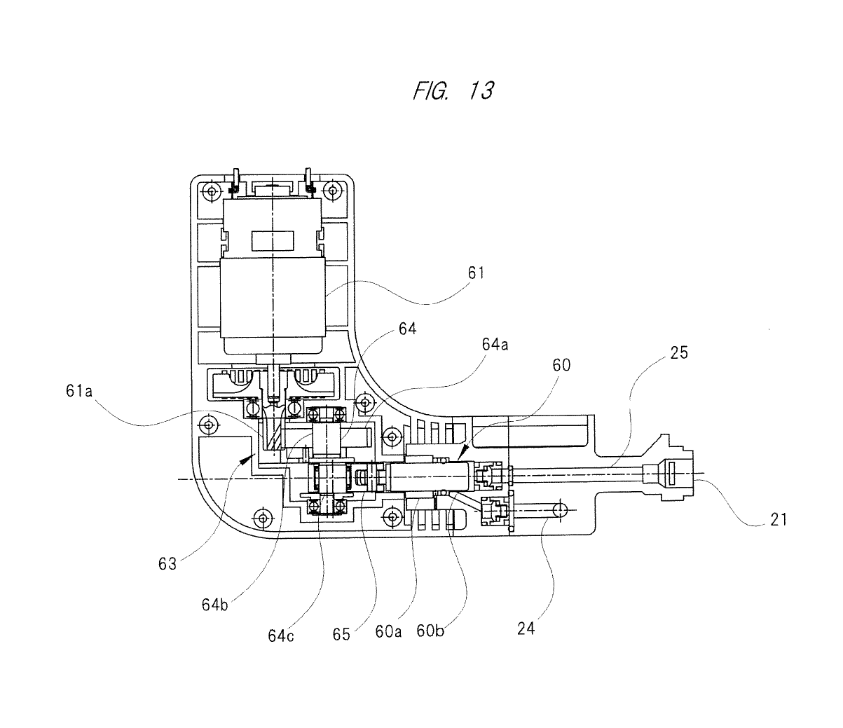

### BRIEF DESCRIPTION OF DRAWINGS

[FIG. 1] FIG. 1 is an exterior perspective view of a main body and a tank of a washer according to the first embodiment;

[FIG. 2] FIG. 2 is a side view of a washing gun of the washer according to the first embodiment;

[FIG. 3] FIG. 3 is a cross-sectional view of a nozzle housed in the washing gun;

[FIG. 4] FIG. 4 is a longitudinal cross-sectional view of the main body and the tank;

[FIG. 5] FIG. 5 is a lateral cross-sectional view of the main body;

[FIG. 6] FIG. 6 is a diagram illustrating a logical discharge waveform of the washer fluid according to a single plunger system;

[FIG. 7] FIG. 7 is a diagram illustrating a practical discharge waveform of the washer fluid according to the single plunger system;

[FIG. 8] FIG. 8 is a diagram illustrating each average value of the discharge pressure, the discharge volume, the pressure liquid volume ratio, and the nozzle diameter in a current commercial washer;

[FIG. 9] FIG. 9 is a diagram illustrating a relation between the discharge pressure and the nozzle diameter in the current commercial washer;

[FIG. 10] FIG. 10 is a view illustrating principal components of the washer according to the first embodiment;

[FIG. 11] FIG. 11 is a diagram illustrating relations among a rated voltage, a battery capacity, a battery energy, output, and operation time;

[FIG. 12] FIG. 12 is a diagram illustrating some examples of combinations of the discharge pressure, the discharge volume, the pressure liquid volume ratio, and the nozzle diameter in the washer of the present invention; and

[FIG. 13] FIG. 13 is a partial cross-sectional view illustrating one example of a positional relation between the pump and the flow path.

### DESCRIPTION OF EMBODIMENTS

### First Embodiment

Hereinafter, one example of a washer to which the present invention is applied will be explained in detail with respect to drawings. The washer 1 according to the present embodiment has: a main body 20 illustrated in FIG. 1; and a washing gun 30 serving as a spray device illustrated in FIG. 2. The main body 20 illustrated in FIG. 1 and the washing gun 30 illustrated in FIG. 2 are connected with each other through a pressure-resistant hose 40 (FIG. 2) serving as a tube member. One end of the pressure-resistant hose 40 is fixed to the washing gun 30, and the other end of the pressure-resistant hose 40 is detachable to the main body 20 (FIG. 1).

As illustrated in FIG. 1, a tank 50 is mounted on the main body 20, and the main body 20 and the tank 50 have substantially a cuboid exterior as a whole. Onto a front surface of the main body 20, a connection port 21 connected to one end of the pressure-resistant hose 40 illustrated in FIG. 2 is provided. When a main switch (not illustrated) provided to the main body 20 is operated, the washer fluid pressurized by a pump described later is discharged from the connection port 21, and is supplied to a washing gun 30 (FIG. 2) through the pressure-resistant hose 40 (FIG. 2) connected to the connection port 21. And, when a trigger 31 provided to the washing gun 30 is operated, the washer fluid supplied to the washing gun 30 is discharged from a head of the washing gun 30 to the target object not illustrated.

In the head of the washing gun 30 illustrated in FIG. 2, a metallic nozzle 32 illustrated in FIG. 3 is embedded. The nozzle 32 is provided with: a flow inlet 34 which communicates with a connection flow path 33 formed inside the washing gun 30; a discharge outlet 35 from which the washer fluid is discharged (sprayed); and a flow path 36 through which the flow inlet 34 and the discharge outlet 35 communicate with each other. That is, the washer fluid supplied to the washing gun 30 through the pressure-resistant hose 40 illustrated in FIG. 2 flows into the nozzle 32 through the connection flow path 33 illustrated in FIG. 3. More specifically, the washer fluid flows from the flow inlet 34 of the nozzle 32 into the nozzle 32. The washer fluid flowing into the nozzle 32 passes through the flow path 36, reaches the discharge outlet 35, and is discharged from the discharge outlet 35 to outside. Here, the flow path 36 formed inside the nozzle 32 is configured of a front portion 36a having a relatively large diameter and a rear portion 36b having a relatively small diameter. Therefore, in the present embodiment, the diameter of the flow-path rear portion 36b corresponds to the minimum diameter of the flow path 36. Reasonably, an embodiment having a uniform diameter of the flow path 36 is possible. Either way, the minimum value of the diameter of the flow path 36 is preferably 0.9 [mm] or smaller, and is 0.75 [mm] in the present embodiment. That is, the diameter of the flow-path rear portion 36b illustrated in FIG. 3 is 0.75 [mm]. In the following explanation, the diameter of the flow-path rear portion 36b is referred to as “nozzle diameter” in some cases. In the nozzle 32 illustrated in FIG. 3, note that a diameter of the discharge outlet 35 and the nozzle diameter are substantially the same as each other. However, the diameter of the discharge outlet 35 may be smaller or larger than the nozzle diameter.

In each of both ends of the flow-path front portion 36a, a taper portion whose end is gradually sharpened along a flow direction of the washer fluid is formed. Also, an O-ring 37 serving as a sealing member is arranged between an outer peripheral surface of the nozzle 32 and an inner peripheral surface of the washing gun 30 so as to increase water tightness. Note that a sealing member is appropriately arranged in not only the part between the outer peripheral surface of the nozzle 32 and the inner peripheral surface of the washing gun 30 but also other part(s) so as to increase the water tightness.

As illustrated in FIG. 4, the tank 50 is overwrapped on the main body 20. More specifically, while a plurality of convex portions 51 are formed on a bottom surface of the tank 50, a plurality of concave portions 22 are formed on a top surface of the main body 20. And, the tank 50 is positioned by fitting the convex portions 51 formed on the bottom surface of the tank with the concave portions 22 formed on the top surface of the main body. Also, as illustrated in FIG. 1, while a buckle 23 is provided to a front surface of the main body 20 and a rear surface of the same, a latch portion 52 is provided to a front surface of the tank 50 and a rear surface of the same. And, when the buckle 23 provided to the main body 20 is latched with the latch portion 52 provided to the tank 50, the tank 50 is fixed to the main body 20. That is, when the buckle 23 is latched with the latch portion 52, the main body 20 and the tank 50 are coupled to each other, and are integrated with each other. Meanwhile, when the latching of the buckle 23 with the latch portion 52 is released, the coupling between the main body 20 and the tank 50 is released, and therefore, the main body 20 and the tank 50 can be separated from each other. Therefore, when a handle 53 provided to the tank 50 is grabbed and the tank 50 is lifted under a state of the release of the coupling between the main body 20 and the tank 50, the tank 50 is separated from the main body 20, so that only the tank 50 can be carried. For example, when the washer fluid (tap water) is poured into the tank 50, only the tank 50 can be carried to a location where a faucet of the tap water is set. Note that a screw-type cap 54 is provided to the tank 50, and is removed when the washer fluid is poured into the tank 50 and when the washer fluid in the tank 50 is discarded.

As illustrated in FIGS. 4 and 5, in the main body 20, a pump 60 for pressurizing the washer fluid supplied from the tank 50, an electric-powered motor 61 which is a driving source of the pump 60, and a battery pack 62 which is a power source of the electric-powered motor 61 are housed. The battery pack 62 in the present embodiment is provided with a rechargeable secondary battery, and is detachable also to an electric-powered tool such as an impact driver. In the present embodiment, two sets each including series-connected four lithium ion batteries are connected in parallel to each other. Each lithium ion battery has a rated voltage of 3.6 [V] and a capacity of 1.5 [Ah]. That is, a total of eight lithium ion batteries are housed in the battery pack 62. In other words, the battery pack 62 is a battery pack having a rated voltage of 14.4 [V] and a capacity of 3.0 [Ah]. Note that the secondary battery may be not the lithium battery but a nickel hydrogen battery or a nickel cadmium battery.

The pump 60 is a plunger pump provided with a cylinder 60a and a plunger 60b serving as a reciprocating member housed in the cylinder 60a so as to freely reciprocate. The rotating motion of the electric-powered motor 61 is converted into the reciprocating motion of the plunger 60b by a conversion mechanism 63 which interposes between the electric-powered motor 61 and the pump 60. As illustrated in FIG. 5, the electric-powered motor 61 is provided with an output shaft 61a having a pinion formed thereon, and a crankshaft 64 is arranged in vicinity of the output shaft 61a. The crankshaft 64 has: a gear 64a which engages with the pinion formed on the output shaft 61a of the electric-powered motor 61; and an eccentric shaft formed of a first shaft portion 64b which protrudes from one surface of the gear 64a and a second shaft portion 64c which protrudes from the other surface of the gear 64a. Each of the first shaft portion 64b and the second shaft portion 64c is supported by a bearing so as to freely rotate. And, while a center of the first shaft portion 64b coincides with a center of the gear 64a, a center of the second shaft portion 64c does not coincide with a center of the gear 64a. That is, the second shaft portion 64c is eccentric with respect to the gear 64a and the first shaft portion 64b. The second shaft portion 64c is coupled to the plunger 60b of the pump 60 through a conrod 65. More specifically, one end of the conrod 65 is coupled to the second shaft portion 64c so as to freely rotate, and the other end of the conrod 65 is coupled to the plunger 60b so as to freely rotate. Therefore, when the output shaft 61a of the electric-powered motor 61 rotates, the second shaft portion 64c rotates around the centers of the gear 64a and the first shaft portion 64b as a rotation center, and the plunger 60b coupled to the second shaft portion 64c through the conrod 65 reciprocates inside the cylinder 60a. That is, an eccentric amount of the second shaft portion 64c with respect to the gear 64a and the first shaft portion 64b corresponds to a stroke amount of the plunger 60b.

Here, in a washer provided with two or more plunger pumps, vibration due to the reciprocation of the plunger and the eccentric rotation of the crankshaft can be cancelled by shifting phases of these plunger pumps. However, in order to drive a plurality of plunger pumps, large power is required. Meanwhile, the battery pack 62 is used as the power source in the washer 1 according to the present embodiment, and therefore, it is required to reduce the power consumption as much as possible so as to extend the continuous operation time. Therefore, only one pump (plunger pump) 60 is provided to the washer 1. That is, a single plunger system is employed for the washer 1 according to the present embodiment, and therefore, the vibration cannot be cancelled by shifting the phases of the plurality of plunger pumps. Accordingly, as illustrated in FIGS. 4 and 5, in the washer 1 according to the present embodiment, a counterweight 66 is provided to the crankshaft 64. More specifically, the counterweight 66 is provided to a base of the second shaft portion 64c. Therefore, in the washer 1 according to the present embodiment, the vibration due to the reciprocation of the plunger 60b and the eccentric rotation of the crankshaft 64 is suppressed by the counterweight 66 which rotates together with the crankshaft 64.

Also, in the washer 1 according to the present embodiment for which the single plunger system is employed, the discharge volume of the washer fluid is reduced. A conventional normal washer is provided with three plunger pumps. That is, for the conventional washer, a triple plunger system is employed. In the triple plunger system, three plungers are reciprocated with a phase difference of 120 degrees from one another. Therefore, the washer fluid is continuously discharged in a state with almost no pulsation. Therefore, in the conventional washer for which the triple plunger system is employed, while the continuous high-pressure discharge is possible, the consumed volume of the washer fluid is large.

On the other hand, in the washer 1 according to the present invention for which the single plunger system is employed, a disadvantage of the washer of the above-described triple plunger system is resolved. Also, in the washer 1 according to the present invention for which the single plunger system is employed, the volume (discharge volume) of the washer fluid discharged from the washing gun 30 (nozzle 32) is logically varied during one cycle of the reciprocation of the plunger 60b (one rotation of the crankshaft 64) as illustrated in FIG. 6. That is, the pulsation of 100% is generated. That is, in the washer 1 according to the present invention, a usage volume of the washer fluid is reduced down to about ⅓ a usage volume of the washer of the triple plunger system within the same period of time. That is, the consumed volume of the washer fluid is suppressed as maintaining the discharge pressure.

In the washer 1 according to the present invention, the washing is performed by the washer fluid stored in the tank 50. That is, there is a limitation on the volume of the washer fluid. Meanwhile, to most of the conventional washer, the washer fluid (tap water) is supplied from the running water. That is, the washer fluid is supplied thereto with substantially no limitation. Therefore, there is no problem to employ the triple plunger system for the conventional washer. On the other hand, when the triple plunger system is employed for the washer 1 according to the present invention in which the washing is performed by the washer fluid stored in the tank 50, the washer fluid inside the tank 50 is consumed in a short period of time. Therefore, for the tank-type washer 1 with the limitation on the supplied volume of the washer fluid, the single plunger system in which the consumed volume of the washer fluid can be reduced as maintaining the same discharge pressure as that of the triple plunger system is appropriate. In this manner, the operation time can be lengthened.

And, in the single plunger system, a slide resistance of the reciprocating member is also reduced down to about ⅓ a slide resistance of the triple plunger system. In the triple plunger system, the three plungers are reciprocated, and therefore, a slide resistance between the plunger and the cylinder in which the plunger is housed is large, and the power consumption is increased. On the other hand, in the washer 1 according to the present invention for which the single plunger system is employed, the above-described slide resistance is reduced down to about ⅓, and therefore, the power consumption is decreased. That is, in the washer 1 according to the present invention, an efficiency of the reciprocation of the plunger 60b, that is, the rotation of the electric-powered motor 61 is improved, and therefore, the power consumption is decreased.

In the washer 1 according to the present invention, the electric-powered motor 61 is driven by the power supply from the battery pack 62. That is, there is a limitation on the power supplied to the electric-powered motor 61. Meanwhile, the power is supplied from a commercial power source to the conventional washer, and therefore, there is substantially no limitation on the power supply. When the commercial power source is used as the power source, there is no problem to employ the triple plunger system having a small power saving effect. On the other hand, when the triple plunger system is employed for the washer 1 according to the present invention using the battery pack 62 as the power source, the power of the battery pack 62 is consumed in a short period of time, and the electric-powered motor 61 cannot be driven. Therefore, the single plunger system is appropriate for the cordless-type (battery-driving) washer 1 with the limitation on the power supply, the single plunger system capable of improving the rotation efficiency of the electric-powered motor 61 and capable of suppressing the power consumption of the battery pack 62 as maintaining the same discharge pressure as that of the triple plunger system. In this manner, the operation time can be lengthened.

Further, in the triple plunger system, an electric-powered motor having a large rated voltage is required for overcoming the slide resistance of the three plungers, and therefore, a size of a product itself increases, and a weight thereof increases. On the other hand, in the single plunger system having the smaller number of plungers and the smaller slide resistance than those of the triple plunger system, a small-sized electric-powered motor is enough to be used, and besides, the number of parts can be decreased. Therefore, the product itself can be small and light. In fact, the washer 1 according to the present invention for which the single plunger system is employed is a washer of a cordless type (not required to be connected to the commercial power source) which is small and light and is driven by the battery pack 62. In other words, the washer 1 according to the present invention is a convenient washer which is easily carried /operated in hand and has no limitation on a usage location.

Note that the connection port 21 illustrated in FIG. 1 practically receives such a pressure as preventing the discharge of the washer fluid, from the pressure-resistant hose 40 side. That is, since the minimum diameter value of the flow path 36 is a small value of 0.9 [mm] or smaller (0.75 [mm] in the present embodiment), it is difficult to discharge the washer fluid. When the pressure of the connection port 21 increases, the pressure-resistant hose 40 is swollen and the pulsation is suppressed, and therefore, the pulsation (flow variation rate) of 100% as illustrated in FIG. 6 is not caused.

In an extreme example, the pulsation of the washer fluid discharged from the nozzle 32 is close to 0% (the pulsation is small) when the plunger 60b is reciprocated at a high speed, and close to 100% (the pulsation is large) when the plunger 60b is reciprocated at a low speed. However, when the plunger 60b is reciprocated at an extremely high speed, the consumed volume of the washer fluid and the power consumption increase as similar to the case of the triple plunger system. On the other hand, when the plunger 60b is reciprocated at an extremely low speed, the washing ability may be not sufficient, and the vibration due to the pulsation may be large.

Accordingly, in the washer 1 according to the present invention, as illustrated in FIG. 7, the reciprocation (the number of reciprocation cycles) of the plunger 60b, that is, the rotation speed of the electric-powered motor 61 is controlled so that the pulsation of the washer fluid discharged from the nozzle 32 is in a range of 20% or larger, preferably 20% to 60%. More specifically, the rotation speed (rotation number) of the electric-powered motor 61 is controlled in a range of 1000 [rpm] to 5000 [rpm]. In this manner, the washer fluid can be discharged with such a pressure as obtaining the sufficient washing ability as suppressing the consumed volume of the washer fluid. When the rotation speed (rotation number) of the electric-powered motor 61 is in the range of 1000 [rpm] to 5000 [rpm], note that the maximum discharge pressure of the washer fluid is within a range of 0.5 [MPa] to 3.0 [MPa]. Note that the discharge pressure in the present embodiment is higher than a pressure (0.3 [MPa]) of the normal tap water.

Next, in the washer 1 of the single plunger system, a diameter (D) and a stroke (S) of the plunger 60b and the rotation number of the electric-powered motor 61 for obtaining the discharge pressure of 2.0 [MPa] in the nozzle diameter of 0.75 [mm] will be explained in detail. A performance of the pump 60 depends on the diameter (D) of the plunger 60b, the stroke (S) thereof, and the number (N) of reciprocation cycles thereof, and the discharge volume (B) of the washer fluid discharged for one minute is expressed by an expression 1.

(B) [L/min]=D [mm]×S [mm]×N [rpm]×k (1)

In the expression 1, the diameter (D) represents a dimension of the plunger 60b in a radius direction, the stroke (S) represents a distance between dead centers of the plunger 60b, and “k” represents a coefficient (constant value). In order to achieve a predetermined discharge volume (B) [L/min] when the number (N) of reciprocation cycles of the plunger 60b is constant (when the rotation number of the electric-powered motor 61 is constant), it is required to adjust the diameter (D) and the stroke (S). More specifically, it is required to increase the diameter (D) but decrease the stroke (S) or decrease the diameter (D) but increase the stroke (S).

When the diameter (D) is increased, an area in which the washer fluid is pushed out by the plunger 60b is increased. For example, a thrust force required for obtaining 2.0 [MPa] when the diameter (D) is 10 [mm] is 157 [kg] (=radius×radius×pi×pressure). When the diameter (D) increases by 2 [mm], the required thrust force is 226 [kg]. That is, the increase in the diameter (D) by only 2 [mm] has to increase the thrust force by 69 [kg]. In order to increase the thrust force, the electric-powered motor 61 has to be changed to a high-power (large-sized) motor, and besides, the cylinder 60a and a housing (main body 20) which receive a reaction force have to be strengthened. In this manner, the size of the washer 1 increases, and a cost adversely increases.

Meanwhile, when the stroke (S) is increased, a moving amount of the plunger 60b is increased. For example, in order to increase the stroke (S) by 5 [mm], it is required to increase a radius of the crankshaft 64 by 2.5 [mm]. And, when the stroke (S) increases by 5 [mm], it is required to increase a total length of a compression chamber (a room for storing the washer fluid, positioned on an opposite side of the crankshaft 64 side of the plunger 60b) in accordance with the extension distance of the stroke (S). That is, when the stroke (S) increases by 5 [mm], the extension of 7.5 [mm] is totally required, which results in the increase in the size of the washer 1. Further, when the stroke (S) increases by 10 [mm], it is required to increase each of the radius of the crankshaft 64 and the total length of the compression chamber by 5 [mm].

Still further, when the number (N) of reciprocation cycles of the plunger 60b is constant, time taking for one stroke is constant (at dt [seconds]), and therefore, an average plunger speed (U) [m/s] can be expressed by an expression 2.

U [m/s]=N [rpm]/60 [seconds]×(S) [m]×2 (2)

When the number (N) of reciprocation cycles of the plunger 60b is constant at 2000 [rpm], the speed (U) is 0.33 [m/s] in the stroke (S) of 5 [mm], and 0.67 [m/s] in the stroke (S) of 10 [mm]. That is, when the stroke (S) is double, the average plunger speed (U) [m/s] is also double. The plunger 60b reciprocates as contacting the cylinder 60a and others. Therefore, when the speed is increased by the increase in the stroke (S), it is required to use a material having a higher abrasion resistance, which results in increase in a cost.

Next, a case in which the number (N) of reciprocation cycles of the plunger 60b is variable will be considered. In a case of any number (N) of reciprocation cycles, it is required to adjust the number (N) of reciprocation cycles and a pushed volume (J) in order to achieve a predetermined discharge volume (B). Here, the pushed volume (J) is a value obtained by multiplying a cross-sectional area of the plunger 60b by the stroke (S).

When the number (N) of reciprocation cycles is increased, the pushed volume (J) can be decreased, and therefore, the size of the plunger 60b can be decreased. The pressure-resistant hose 40 is interposed between the plunger 60b and the nozzle 32, and therefore, the pulsation is suppressed by expanding and contracting this pressure-resistant hose 40. That is, when the washer fluid is discharged at a high speed (finely), the discharge pulsation is smaller than that in the logical discharge waveform (FIG. 6) of the single plunger system, and therefore, the effect of the limitation on the discharge volume is small.

On the other hand, when the number (N) of reciprocation cycles is decreased, the pushed volume (J) is increased, and therefore, the size of the plunger 60b is adversely increased. In this case, the discharge pulsation is close to the logical discharge waveform (FIG. 6) of the single plunger system. In other words, the discharge pulsation is large, and therefore, the effect of the limitation on the discharge volume can be increased. However, the pulsation becomes a cause of occurrence of the vibration, and therefore, an extremely small number (N) of reciprocation cycles is not preferable.

Therefore, it is required to appropriately set the diameter (D), the stroke (S), and the number (N) of reciprocation cycles of the plunger 60b in consideration of the size, the cost, and the discharge volume of the product, and others. The inventors of the present invention have experimentally obtained an appropriate range in which the discharge volume and the power consumption amount can be suppressed and the vibration can be suppressed as suppressing the increases in the size and the cost of the product. As a result, they have obtained such knowledge that the diameter (D) of the plunger is preferably within a range of 5 to 20 [mm], the stroke (S) of the plunger is preferably within a range of 3 to 10 [mm], and the number (N) of reciprocation cycles of the plunger is preferably within a range of 1000 to 5000 [rpm]. Accordingly, in the present embodiment, it is set that the diameter (D) of the plunger is 12 [mm], the stroke (S) thereof is 5 [mm] (an eccentric amount of the crankshaft 64 is 2.5 [mm]), and the number (N) of reciprocation cycles of the plunger is 2000 [rpm] in order to obtain the maximum discharge pressure of 3.0 [MPa] (preferably, 2.0 [MPa]) when the nozzle diameter (minimum diameter) is 0.90 [mm] or smaller (preferably, 0.75 [mm]). Further, in the present embodiment, the vibration is further suppressed by providing the counterweight 66.

Also, in the single plunger system, the discharge pulsation is logically 100% as illustrated in FIG. 6. However, practically, the discharge volume (pulsation) does not reach 100% since the pressure-resistant hose 40 expands and contracts to function as a pressure accumulator. The practical pulsation is in a range of 20 to 60% as illustrated in FIG. 7. Therefore, if the discharge pulsation is in at least the range of 20 to 60%, the discharge volume is lower than that of the triple plunger system.

That is, when the discharge pulsation is 20 to 60% of the maximum discharge pressure (3.0 [MPa]), the minimum discharge pressure is 1.2 [MPa] to 2.4 [MPa]. Also, when the maximum discharge pressure is 2.0 [MPa], the minimum discharge pressure is 0.8 [MPa] to 1.6 [MPa].

Here, continuous time of the maximum discharge pressure is certain time (moment) during one reciprocation cycle of the plunger 60b. That is, the rest of the time when the discharge pressure of the washer fluid is at the maximum is extremely longer than the time when the discharge pressure of the washer fluid is at the maximum. As illustrated in FIG. 7, the time when the pulsation is within 20% (at the high-pressured discharge) is in a region (time) from “t1” to “t2” during one reciprocation cycle of the plunger 60b, and the time when the pulsation is 20% or larger is the rest region (time). Therefore, when the region of the pulsation within 20% is set to the maximum pressure region, the time of the pulsation within 20% is about ¼ the time during one reciprocation cycle of the plunger 60b, and therefore, the discharge volume (consumed volume of the washer fluid) is reduced.

As described above, in the single plunger system, the discharge pressure is raised for each stroke of the plunger up to the same peak value as that of the triple plunger system. At this time, the discharge pressure pulses. Therefore, the consumed volume of the washer fluid is reduced lower than that of the triple plunger system in which the washer fluid is continuously discharged. Also, a region “A” illustrated in FIG. 7 represents a total of the practically-discharged volume (discharge volume (B)) of the washer fluid, that is, represents a working amount of the pump 60. The working amount of the pump 60 is about half (logically ⅓) the working amount of the triple plunger system, and the power consumption of the battery pack 62 is suppressed.

Further, in the washer 1 according to the present embodiment, the plunger 60b is reciprocated by the crankshaft 64. Therefore, the slide resistance is less than a slide resistance of a configuration in which the plunger is reciprocated by a rotational swash plate. Also in this point, the power consumption is suppressed.

FIG. 5 is referred to again. A first flow path 24 which communicates between the tank 50 (FIG. 4) and the pump 60 is provided inside the main body 20. Also, as illustrated in FIG. 4, a second flow path 25 which communicates between the pump 60 and the connection port 21 is also provided inside the main body 20. The washer fluid stored in the tank 50 is supplied to the pump 60 through the first flow path 24, and is pressurized. Further, the washer fluid pressurized by the pump 60 is fed to the connection port 21 through the second flow path 25. Accordingly, in the following explanation, the first flow path 24 which communicates between the tank 50 and the pump 60 is referred to as “flow-in path 24”, and the second flow path 25 which communicates between the pump 60 and the connection port 21 is referred to as “flow-out path 25”. That is, the washer fluid stored in the tank 50 is supplied to the pump 60 through the flow-in path 24 and is pressurized. Also, the washer fluid pressurized by the pump 60 is fed to the connection port 21 through the flow-out path 25. Note that the supply of the washer fluid fed to the connection port 21 followed by the washing gun 30 through the pressure-resistant hose 40 connected to the connection port 21 has been already described above (in FIG. 3).

As illustrated in FIG. 5, one end of the flow-in path 24 is connected to an inlet provided on an end surface of the cylinder 60a, and the other end of the flow-in path 24 is provided with a non-illustrated connection plug connected to the tank 50 (FIG. 4). A check valve is provided to a base surface of the tank 50 although not illustrated. When the tank 50 is overlapped with the main body 20 as illustrated in FIG. 4, the check valve is opened by the connection plug so that the tank 50 and the flow-in path 24 communicate with each other. More specifically, a valving element of the check valve is pushed up by the connection plug, and is separated from a valve seat. Then, a gap is generated between the valving element and the valve seat, and the tank 50 and the flow-in path 24 communicate with each other so as to interpose this gap therebetween. Note that a spring which presses the valving element against the valve seat is provided to the check valve, and the gap is closed by automatically pressing the valving element against the valve seat when the tank 50 is pulled up from the main body 20.

A one-way valve is provided to each of an inlet and an outlet of the cylinder 60a. When the plunger goes backward (moves rightward on a sheet of each of FIGS. 4 and 5) in the state in which the tank 50 and the flow-in path 24 communicate with each other as described above, the one-way valve provided to the inlet of the cylinder 60a is opened, whereas the one-way valve provided to the outlet of the cylinder 60a is closed, so that the washer fluid is flowed into the cylinder 60a. Subsequently, when the plunger goes forward (moves leftward on the sheet of each of FIGS. 4 and 5), the one-way valves provided to the inlet and the outlet of the cylinder 60a are closed, so that the washer fluid in the cylinder 60a is pressurized. Then, when the pressure of the washer fluid in the cylinder 60a reaches the predetermined pressure, only the one-way valve provided to the outlet of the cylinder 60a is opened as closing the one-way valve provided to the inlet of the cylinder 60a, so that the pressurized washer fluid is fed from the cylinder 60a to the flow-out path 25. The washer fluid fed to the flow-out path 25 is fed to the connection port 21 through the flow-out path 25, and is discharged from the connection port 21.

As illustrated in FIG. 4, the flow-out path 25 is linear, and is arranged on the same plane as that of the pump 60 (plunger 60b). More specifically, an axis line of the plunger 60b and an axis line of the flow-out path 25 are positioned on the same plane as each other. That is, the plunger 60b and the flow-out path 25 are in parallel to each other. By forming the flow-out path 25 to be linear and arranging the flow-out path 25 on the same plane as that of the plunger 60b, the pulsation of the washer fluid is suppressed, and vibrations of the pump 60 and others are suppressed.

The pressure of the washer fluid discharged from the connection port 21 as described above, that is, the maximum discharge pressure is preferably 0.5 [MPa] or higher and 9.0 [MPa] or lower, and more preferably 0.5 [MPa] or higher and 3.0 [MPa] or lower. In the washer 1 according to the present embodiment, it is set that the discharge pressure of the washer fluid is 2.0 [MPa].

Here, the supply of the washer fluid discharged from the connection port 21 to the washing gun 30 (FIG. 2) through the pressure-resistant hose 40 (FIG. 2) connected to the connection port 21 has been already described above. Also, the flow of the washer fluid supplied to the washing gun 30 to the flow path 36 from the flow inlet 34 of the nozzle 32 illustrated in FIG. 3 has been also already described above. That is, while a continuous flow path is formed of the pressure-resistant hose 40 (FIG. 2) and the connection flow path 33 (FIG. 3) between the connection port 21 of the main body 20 and the flow inlet 34 of the nozzle 32, any pressure loss is hardly caused in this continuous flow path. In other words, a pressure of the washer fluid at the flow inlet 34 of the nozzle 32a pressure of the washer fluid at the connection port 21 and are substantially the same as each other. Therefore, a pressure of the washer fluid at any point in the continuous flow path formed of the pressure-resistant hose 40 (FIG. 2) and the connection flow path 33 (FIG. 3) can be identified as the pressure of the washer fluid discharged from the connection port 21.

In the washer 1 according to the present embodiment having the nozzle diameter of 0.75 [mm] and the discharge pressure (particularly the maximum discharge pressure) of the washer fluid of 2.0 [MPa] as described above, the washer fluid of 1 [L] (1 liter) per minute is discharged from the discharge outlet 35 of the nozzle 32 illustrated in FIG. 3. In other words, a ratio (A/B) between the discharge pressure (A) of the washer fluid in the washer 1 and the discharge volume (B) thereof is 2.0. In the following explanation, the ratio (A/B) between the discharge pressure (A) of the washer fluid and the discharge volume (B) is referred to as “pressure liquid volume ratio” in some cases.

A table illustrated in FIG. 8 and a graph illustrated in FIG. 9 are a table and a graph showing results of the current commercial washer studied by the inventors of the present invention. A top column of the table illustrated in FIG. 8 shows average values of the discharge pressure, the discharge volume, the pressure liquid volume ratio, and the nozzle diameter in a plurality of washers (hereinafter, referred to as “AC washer”) driven by an alternate-current power source. A middle column of the table shows average values of the discharge pressure, the discharge volume, the pressure liquid volume ratio, and the nozzle diameter in a plurality of washers (hereinafter, referred to as “DC washer”) driven by a direct-current power source. A bottom column of the table shows the discharge pressure, the discharge volume, the pressure liquid volume ratio, and the nozzle diameter in the washer 1 according to the present embodiment. Also, the graph illustrated in FIG. 9 shows a relation between the discharge pressure and the nozzle diameter in each of the AC washer, the DC washer, and the washer 1 according to the present embodiment.

As seen from the table illustrated in FIG. 8, the average value of the pressure liquid volume ratio (AB) in the conventional washer is smaller than 1.5. More particularly, the average value of the pressure liquid volume ratio (AB) in the conventional DC washer is smaller than 0.5. That is, in the conventional washer, the discharge pressure with respect to the discharge volume is small. Consciously speaking, in the conventional washer, a large volume of the washer fluid is discharged at a low pressure.

On the other hand, the pressure liquid volume ratio (AB) in the washer 1 according to the present embodiment is 2.0. That is, in the washer 1 according to the present embodiment, a small volume of the washer fluid is discharged at a higher pressure than that in the conventional washer. Therefore, the washer 1 according to the present embodiment has the washing ability equivalent to or higher than that of the conventional washer. Further, if the tank volumes are the same as each other, the washer 1 according to the present embodiment can be continuously used for a longer period of time than that of the conventional washer.

Here, in the cordless-type washer 1 provided with the tank 50 and the battery pack 62 used as the power source, selection of a capacity of the battery pack 62 providing the high-pressurized discharge (the discharge pressure equal to or higher than the pressure of the tap water of 0.3 [MPa]) will be explained.

As illustrated in FIG. 10, principal components of the washer 1 are the battery pack 62, the electric-powered motor 61, and the pump 60. There is a limitation on the supplied power from the battery pack 62, and the power consumption of the battery pack 62 depends on efficiencies of the electric-powered motor 61 and the pump 60 and others.

When an energy conversion efficiency of each component is considered, there are a first conversion efficiency (c1) which converts the power of the battery pack 62 into the rotating motion of the electric-powered motor 61 and a second conversion efficiency (c2) which converts the rotating motion of the electric-powered motor 61 into the reciprocating motion (the pressuring motion of the washer fluid) of the pump 60 (plunger 60b). Each of these conversion efficiencies is ideally 100%. However, practically, the first conversion efficiency (c1) and the second conversion efficiency (c2) are not 100% because of a copper loss, an iron loss, a mechanical loss and others, and because of a mechanical loss, a tube loss, and others, respectively. That is, by selecting the battery pack 62 and the electric-powered motor 61 so as to match each efficiency (c1 and c2), the cordless-type (battery-driving) washer 1 which enables the high-pressurized discharge can be achieved.

First, based on the second conversion efficiency (c2), a motor output required for driving the pump 60 will be studied. A power “W2” (motor output, second power) required for driving the pump 60 can be regularly expressed by an expression 3 when the discharge pressure is set to (A) and the discharge volume is set to (B).

W2 [W]=(A) [MPa]×(B) [L/min]×1000/60/(c2) (3)

Here, when the discharge pressure (A) is 2.0 [MPa] and the discharge volume (B) is 1 [L/min], if the second conversion efficiency (c2) is assumed to be 50 to 80% as similar to the pump efficiency of the general washer, the power (W2) is about 40 to 70 [W]. Therefore, the power (W2) required for driving the pump 60 is about 40 to 70 [W]. Note that the powers (W2) obtained when the discharge pressures (A) are 0.5, 3.0, and 9.0 [MPa] in the discharge volume (B) of 1 [L/min] are about 10 to 20 [W], about 60 to 100 [W], and about 190 to 300 [W], respectively.

Next, the electric-powered motor 61 is driven by the power supplied from the battery pack 62. Accordingly, the power W1 (first power) of the battery pack 62 required for obtaining the power (W2) of about 40 to 70 [W] will be considered. Since the power (W2) is the value obtained by multiplying the battery-pack power (W1) by the first conversion efficiency (c1), the battery-pack power (W1) is a value obtained by dividing the power (W2) by the first conversion efficiency (c1).

Here, when the electric-powered motor 61 is a general direct-current motor, a motor efficiency is 50% to 80%. Accordingly, if the first conversion efficiency (c1) is assumed to be 50% to 80%, when the discharge pressure (A) is 2.0 [MPa], the first power [W1] is about 50 to 140 [W]. When the discharge pressure (A) is 0.5 [MPa], the first power [W1] is about 12 to 34 [W]. When the discharge pressure (A) is 3.0 [MPa], the first power [W1] is about 75 to 200 [W]. When the discharge pressure (A) is 9.0 [MPa], the first power [W1] is about 240 to 600 [W]. Therefore, when the discharge pressure (A) is 2.0 [MPa], the power (W1) required for a combination providing the worst efficiency between the power (W1) and the power (W2) is 140 [W]. When the electric-powered motor 61 is a brushless motor, the motor efficiency is improved, and therefore, note that there is no problem for the power (W1) less than 140 [W]. That is, the minimum power of the battery pack 62 can be appropriately set in accordance with a type of a motor to be used.

Next, the battery pack 62 will be explained. As described above, the power required for the battery pack 62 is 140 [W] when the discharge pressure (A) is 2.0 [MPa]. Meanwhile, when the washer fluid of 8 [L] can be stored in the tank 50, it is desired to discharge all washer fluid of 8 [L] for one operation (one charge of the battery pack 62). Therefore, when the discharge volume (B) of the washer fluid is 1 [L/min], the battery energy of 18.7 [Wh] is required for the battery pack 62 (140 [W]×8 [L]/1 [L/min]=1120 [W×min]).

The number of lithium ion batteries required for obtaining the power of 140 [W] will be considered. When a rated voltage of the lithium ion battery cell is set to 3.6 [V] and a discharge current is set to 20 [A], at least two battery cells are required (3.6 [V]×(series- or parallel-connected) 2 battery cells×20 [A]=144 [W]). Therefore, for example, a battery pack of 7.2 [V] or higher in which the battery cells are connected in series to each other can be used. A rated voltage [V] of a battery pack used for an electric-powered tool is generally 3.6, 7.2, 10.8, 14.4, 18.0, 25.2, or 36.0 [V]. Also, a battery capacity [Ah] of the battery pack used for the electric-powered tool is generally 1.5, 2.0, 3.0 or 4.0 [Ah]. The battery voltage depends on the number of the series-connected battery cells, and the battery capacity depends on the number of the parallel-connected battery cells. For example, when two battery cells each having the rated voltage of 3.6 [V] are connected in series to each other, the battery voltage is 7.2 [V]. Also, when two battery cells each having the battery capacity of 2.0 [Ah] are connected in parallel to each other, the battery capacity is 4.0 [Ah]. While the voltages and the capacities of the battery cells variously depend on battery cell manufacturers, a battery cell having the rated voltage of 3.6 [V] and the capacity of 2.0 [Ah] will be explained as an example.

For example, a battery energy of a battery pack having the rated voltage of 14.4 [V] and the battery capacity of 1.5 [Ah] is 21.6 [Wh], and therefore, can satisfy the required battery energy of 18.7 [Wh]. That is, the battery pack can satisfy the required battery energy as long as having the rated voltage of 14.4 [V] or higher. Note that even a battery pack having a rated voltage of 14.4 [V] or lower can satisfy the required battery energy of 18.7 [Wh] by connecting the predetermined number of battery cells in parallel to each other.

Next, the operation time will be considered. For example, in a case of a battery pack having the rated voltage of 14.4 [V] and the battery capacity of 1.5 [Ah], the battery energy is 21.6 [Wh]. When the minimum power (W1) of the battery pack is 140 [W], the operation can be performed for about 9 minutes (21.6 [Wh]×60 [minutes]/140 [W]). Therefore, when the discharge volume (B) 1 [L/min], the washer fluid (8 L) of the tank 50 can be consumed. That is, the time while the washer fluid of the tank 50 of the washer 1 can be consumed can be secured.

As descried above, a rated voltage [V], a battery capacity [Ah], a batter energy [Wh], and operation time [minutes] of a battery pack 62 which satisfy the required battery output of 140 [W] and the battery energy of 18.7 [Wh] and which are required for securing the operation time required for consuming the washer fluid of 8 [L] are as illustrated in FIG. 11. At this time, the discharge pressure (A) is 2.0 [MPa], the discharge volume (B) is 1 [L/min], the battery output (W1) is 140 [W], and the average discharge current (I) is 20 [A] (per battery cell).

Note that the rated voltage of the battery pack 62 in the present embodiment is 14.4 [V], and the battery capacity thereof is 3.0 [Ah] or 4.0 [Ah]. Therefore, the operation time long enough to consume the washer fluid of 8 [L] stored in the tank 50 can be secured.

As described above, in consideration of the first conversion efficiency c1 (50 to 80%) from the battery pack 62 to the electric-powered motor 61 and the second conversion efficiency c2 (50 to 80%) from the electric-powered motor 61 to the pump 60, the minimum power (W2) required for driving the washer 1 by the battery pack 62 has been calculated to be 70 [W], and the battery-pack power (W1) has been calculated to be 140 [W]. Note that the calculations are based on an assumption that the discharge pressure (A) is 2.0 [MPa] and the discharge volume (B) is 1 [L/min]. That is, by setting the power (W2) to 70 [W] or larger and the battery-pack power (W1) to 140 [W] or larger, the cordless-type washer 1 can be provided. Further, by providing the output of 140 [W] or larger and the battery energy of 18.7 [Wh] or larger to the washer, all of the washer fluid stored in the tank 50 can be discharged. Note that the electric-powered motor 61 has been explained as a commutating direct-current motor in the present embodiment, and therefore, the conversion efficiency is set to 50% to 80%. However, if the electric-powered motor is a brushless motor, the conversion efficiency is improved (up to be 80% or higher), so that the power required for the battery pack 62 can be suppressed. If the conversion efficiency (c1) of the brushless motor is 90%, the power (W2) is about 40 to 70 [W] or larger (conversion efficiency (c2) is 50% to 80%), and the batter-pack power (W1) is about 40 to 80 [W]. That is, even in the case of the worst efficiency, only about 80 [W] is enough for the required batter-pack power (W1).

As described above, by providing only one pump (plunger) 60 to the washer 1 according to the present embodiment, the power consumption of the battery pack 62 and the discharge volume of the washer fluid are reduced, and besides, the necessary and sufficient washing ability can be maintained. The washer 1 according to the present embodiment having such characteristics is particularly suitable for indoor use. More specifically, the washer is suitable for cleaning an air-conditioner indoor unit, a net window (screen door), and others, that is, for housecleaning. This is because, when the washer having the large discharge volume is used indoors, there is a risk of getting dirty on a floor due to dripping off of the discharged washer fluid onto the floor. Also, when the floor is previously covered with a plastic sheet or others in order to prevent getting dirty on the floor, a large volume of the washer fluid stays on the plastic sheet, and it takes time and effort to treat the washer fluid thereon after that. In this point, according to the washer 1 of the present embodiment having the high washing ability with the small discharge volume, a possibility of occurrence of such inconvenience as described above is extremely low. More particularly, when the discharge pressure is 0.5 [MPa] to 3.0 [MPa], the discharge pressure is not too high and not too low. The air-conditioner indoor unit, the net window, and others can be cleaned without being damaged by a water pressure. Also, the washer fluid does not bounce back onto the substance to be cleaned. Incidentally, as illustrated in FIG. 8, an average discharge pressure of a general AC washer is 5 [MPa] or higher, and an average discharge pressure of a general DC washer is 0.6 [MPa] or lower. As a matter of course, the washer 1 according to the present embodiment can be used not only indoor but also outdoor.

The present invention is not limited to the foregoing embodiment and various modifications and alterations can be made within the scope of the present invention. For example, in the washer 1 according to the embodiment, the discharge pressure (A) of the washer fluid is 2.0 [MPa], the discharge volume (B) of the washer fluid is 1 [L/min], the pressure liquid volume ratio (A/B) is 2.0, and the nozzle diameter is 0.75 [mm] However, these numerical values represent one example, and it is confirmed that the necessary and sufficient washing ability can be obtained with the small discharge volume if the pressure liquid volume ratio (A/B) is 1.8 or larger in a range of the discharge pressure (particularly the maximum discharge pressure) of the washer fluid of 0.5 [MPa] or higher and 9.0 [MPa] or lower through investigations and tests made by the inventors of the present invention. Here, the necessary and sufficient washing ability is based on a washing ability required when the washer is mainly used for the housecleaning. That is, the necessary and sufficient washing ability for cleaning an air-conditioner indoor unit, a net window, a window, a bathtub, a sink in a kitchen, a range hood, and others can be obtained with a smaller discharge volume than a conventional one. Accordingly, FIG. 12 illustrates some examples of combinations among the discharge pressure, the discharge volume, the pressure liquid volume ratio, and the nozzle diameter, which satisfy the above-described conditions.

Also, in the washer 1 according to the embodiment, the pump 60 (the cylinder 60a and the plunger 60b) and the flow-out path 25 are vertically arranged as illustrated in FIG. 4. However, as illustrated in FIG. 13, the pump 60 (the cylinder 60a and the plunger 60b) and the flow-out path 25 are horizontally arranged. That is, an outlet of the cylinder 60a and the connection port 21 may be linearly connected. In such arrangement, the pulsation of the washer fluid is further suppressed, and vibrations of the pump 60 and others are also further suppressed. Also in the arrangement illustrated in FIG. 13, note that the plunger 60b and the flow-out path 25 are obviously arranged on the same plane as each other.

The pump 60 provided in the washer 1 according to the embodiment can be replaced by a gear pump or a diaphragm pump. Understandably, the gear pump and the diaphragm pump have less pulsation than the pulsation of the plunger pump. That is, the counterweight 66 and the linear flow-out path 25 are particularly effective when the pump 60 is the plunger pump.

### REFERENCE SIGNS LIST

1 washer

20 main body

21 connection port

22 concave portion

23 buckle

24 first flow path (flow-in path)

25 second flow path (flow-out path)

30 washing gun

31 trigger

32 nozzle

33 connection flow path

34 flow inlet

35 discharge outlet

36 flow path

36a flow-path front portion

36b flow-path rear portion

37 O-ring

40 pressure-resistant hose

50 tank

51 convex portion

52 latch portion

53 handle

54 cap

60 pump

60a cylinder

61 electric-powered motor

61 a output shaft

62 battery pack

63 conversion mechanism

64 crankshaft

64a gear

64b first shaft portion

64c second shaft portion

65 conrod

66 counterweight

1. A washer which pressurizes and discharges washer fluid,
wherein a discharge pressure (A) of the washer fluid is 0.5 [MPa] or higher and 9.0 [MPa] or lower, and
a pressure liquid volume ratio (A/B) which is a ratio of a discharge volume (B) [L/min] of the washer fluid with respect to the discharge pressure (A) [MPa] of the washer fluid is 1.8 or larger.

2. The washer according to claim 1,
wherein the discharge pressure (A) is 0.5 [MPa] or higher and 3.0 [MPa] or lower.

3. The washer according to claim 1,
wherein the discharge pressure (A) is the maximum discharge pressure.

4. The washer according to claim 1,
wherein the discharge volume (B) is 1 [L/min].

5. The washer according to claim 1 further comprising a nozzle including:
a flow inlet into which the washer fluid is flowed;
a discharge outlet from which the washer fluid is discharged; and
a flow path through which the flow inlet and the discharge outlet are communicated to each other,
wherein a minimum value of a diameter of the flow path is 0.9 [mm] or smaller.

6. The washer according to claim 1, further comprising:
a main body including a tank which stores the washer fluid, a pump which pressurizes the washer fluid supplied from the tank, an electric-powered motor which is a driving source of the pump, and a secondary battery which is a power source of the electric-powered motor;
a spray device including a nozzle; and
a tube member which connects the main body with the spray device.

7. The washer according to claim 6,
wherein the secondary battery can supply power of 140 [W] or larger to the electric-powered motor.

8. The washer according to claim 7,
wherein the power supplied to the electric-powered motor by the secondary battery is power obtained when a first conversion efficiency (η1) for converting power of the secondary battery into rotating motion of the electric-powered motor is 50% to 80%.

9. The washer according to claim 7,
wherein power required for driving the pump is 70 [W] or higher.

10. The washer according to claim 9,
wherein the power required for driving the pump is power obtained when a second conversion efficiency (η2) for converting the rotating motion of the electric-powered motor into reciprocating motion of the pump is 50% to 80%.

11. The washer according to claim 6,
wherein the secondary battery can supply power of 20 [Wh] or higher to the electric-powered motor.

12. The washer according to claim 6,
wherein the pump includes single reciprocating member driven by the electric-powered motor, and the discharge pressure is pulsed by the single reciprocating member.

13. The washer according to claim 12,
wherein the discharge pressure is pulsed with a variation rate of 20% or higher.

14. The washer according to claim 6,
wherein the secondary battery is used for an electric-powered tool.

15. A washer which pressurizes and discharges washer fluid, comprising:
a pump which includes a cylinder and a plunger housed in the cylinder so as to freely reciprocate and which pressurizes the washer fluid; and
a crankshaft for converting rotating motion of an electric-powered motor into reciprocating motion of the plunger,
wherein a counterweight which rotates together with the crankshaft is provided to the crankshaft.

16. A washer which pressurizes and discharges washer fluid, comprising:
a pump which includes a cylinder and a plunger housed in the cylinder so as to freely reciprocate and which pressurizes the washer fluid;
a conversion mechanism which converts rotating motion of an electric-powered motor into reciprocating motion of the plunger;
a main body in which the pump and the conversion mechanism are housed;
a spray device which is connected to the main body through a tube member;
a connection port which is provided to the main body and which is connected to one end of the tube member; and
a linear flow path which is provided to the main body and through which the pump and the connection port are communicated to each other,
wherein the plunger and the flow path are arranged on the same plane as each other.
